(19) United States
(12) Patent Application Publication
(10) Pub. No.: US 2023/0068269 A1
(43) Pub. Date: Mar. 2, 2023

(54) PROACTIVE ENGAGEMENT OF CUSTOMERS FOR LLD THROUGH AUTOMATED TRIAL LL SERVICES

(71) Applicant: ARRIS Enterprises LLC, Suwanee, GA (US)

(72) Inventors: Sabarinathan NAGARAJAN, Bangalore (IN); Lakshmi ARUNKUMAR, Bangalore (IN); Ian G. WHEELOCK, Cork (IE)

(21) Appl. No.: 17/896,313

(22) Filed: Aug. 26, 2022

Related U.S. Application Data
(60) Provisional application No. 63/239,536, filed on Sep. 1, 2021.

(51) Int. Cl. H04L 47/2425; H04L 43/0864; H04L 47/283; H04L 12/28

(52) U.S. Cl. CPC H04L 47/2425; H04L 43/0864; H04L 47/283; H04L 12/2801

(57) ABSTRACT

A server device for use with a service provider device, a service receiving device, a provisioning system, a client device, and a user. The server device includes: a memory and a processor configured to execute the instructions stored on the memory to cause the server device to: obtain monitored data application data; obtain a comparison of the monitored data to a low latency data threshold; automatically transmit an instruction to the service provider device or the provisioning system to instruct the service provider device to provide the temporary low latency service flow to the service receiving device; and automatically transmit an instruction to instruct the user of the temporary low latency service flow.

### BACKGROUND

Embodiments of the invention relate to low latency communication systems.

### SUMMARY

Aspects of the present invention are drawn to a server device for use with a service provider device, a service receiving device, a provisioning system, a client device, and a user. The service provider device is configured to provide a service flow to the service receiving device and is configured to provide a low latency service flow to the service receiving device. The low latency service flow has a latency that is lower than that of the service flow. The provisioning system is configured to provision the service receiving device to receive the service flow or the low latency service flow. The client device is configured to operate an application for use by the user and to provide upstream application data based on the application to the service provider device via the service receiving device and to receive downstream application data based on the application from the service provider device via the service receiving device. The server device includes: a memory having instructions stored therein; and a processor configured to execute the instructions stored on the memory to cause the server device to: obtain monitored data based on at least one of the upstream application data and the downstream application data; obtain a comparison of the monitored data to a low latency data threshold; automatically transmit a reconfigure instruction to the service provider device to instruct the service provider device to provide the low latency service flow to the service receiving device for a predetermined period of time and based on the comparison or to the provisioning system to instruct the provisioning system to cause the service provider device to provide the low latency service flow to the service receiving device for a predetermined period of time and based on the comparison; and automatically transmit a message instruction to instruct the user of the low latency service flow and based on the predetermined period of time.

In some embodiments, a cable modem termination system (CMTS) is the service provider device, and a cable modem is the service receiving device. The CMTS is configured to provide the service flow as a data-over-cable service interface specifications (DOCSIS) service flow to the cable modem and is configured to provide the low latency service flow as a low latency DOCSIS (LLD) service flow to the cable modem. The processor is further configured to execute the instructions stored on the memory to further cause the server device to: obtain the comparison as a second comparison of the at least one of the upstream application data and the downstream application data to the low latency data threshold; automatically transmit the reconfigure instruction by automatically transmitting the reconfigure instruction to the CMTS to instruct the CMTS to provide the LLD service flow to the cable modem for a predetermined period of time and based on the second comparison or automatically transmitting the reconfigure instruction to the provisioning system to instruct the provisioning system to cause the CMTS to provide the LLD service flow to the cable modem for a predetermined period of time and based on the second comparison; and automatically transmit the message instruction by automatically transmitting the message instruction to instruct the user of the LLD service flow and based on the predetermined period of time.

In some further embodiments, the processor is further configured to execute the instructions stored on the memory to additionally cause the server device to: store, into the memory, an association between the cable modem and the user; and store, into the memory, contact information of the user. In some of these embodiments, the processor is further configured to execute the instructions stored on the memory to additionally cause the server device to store the contact information of the user as one of a telephone number and an email address. In some further embodiments, the server device is for further use with a wireless network, wherein the client device is configured to communicate with the wireless network based on the telephone number, and wherein the processor is further configured to execute the instructions stored on the memory to additionally cause the server device to: store the contact information of the user as the telephone number; and automatically transmit the message instruction to the client device by way of the wireless network. In some further embodiments, the client device being configured to receive the message instruction based on the email address, the processor is further configured to execute the instructions stored on the memory to additionally cause the server device to: store the contact information of the user as an email address; and automatically transmit the message instruction to the client device using the email address.

In some further embodiments, the processor is further configured to execute the instructions stored on the memory to additionally cause the server device to: automatically transmit a second reconfigure instruction to the CMTS to instruct the CMTS to cease providing the LLD service flow to the cable modem after expiration of the predetermined period of time.

Other aspects of the present disclosure are drawn to a method of using server device with a service provider device, a service receiving device, a provisioning system, a client device, and a user. The service provider device is configured to provide a service flow to the service receiving device and is configured to provide a low latency service flow to the service receiving device. The low latency service flow has a latency that is lower than that of the service flow. The provisioning system is configured to provision the service receiving device to receive the service flow or the low latency service flow. The client device is configured to operate an application for use by the user and to provide upstream application data based on the application to the service provider device via the service receiving device and to receive downstream application data based on the application from the service provider device via the service receiving device. The method includes: obtaining, via a processor, monitored data based on at least one of the upstream application data and the downstream application data; obtaining, via the processor, a comparison of the monitored data to a low latency data threshold; automatically transmitting, via the processor, a reconfigure instruction to the service provider device to instruct the service provider device to provide the low latency service flow to the service receiving device for a predetermined period of time and based on the comparison or to the provisioning system to instruct the provisioning system to cause the service provider device to provide the low latency service flow to the service receiving device for a predetermined period of time and based on the comparison; and automatically transmitting, via the processor, a message instruction to instruct the user of the low latency service flow and based on the predetermined period of time.

In some embodiments, a cable modem termination system (CMTS) is the service provider device, and a cable modem is the service receiving device, the CMTS being configured to provide the service flow as a data over cable service interface specifications (DOCSIS) service flow to the cable modem and being configured to provide the low latency service flow as a low latency DOCSIS (LLD) service flow to the cable modem, wherein the obtaining the comparison includes obtaining the comparison as a second comparison of the at least one of the upstream application data and the downstream application data to the low latency data threshold, wherein the automatically transmitting the reconfigure instruction includes automatically transmitting the reconfigure instruction to the CMTS to instruct the CMTS to provide the LLD service flow to the cable modem for a predetermined period of time and based on the second comparison or automatically transmitting the reconfigure instructions to the provisioning system to instruct the provisioning system to cause the CMTS to provide the LLD service flow to the cable modem for a predetermined period of time and based on the second comparison, and wherein the automatically transmitting the message instruction includes automatically transmitting the message instruction to instruct the user of the LLD service flow and based on the predetermined period of time. In some of these embodiments, the method further includes storing, via the processor and into a memory, an association between the cable modem and the user; and storing, via the processor and into the memory, contact information of the user. In some of these embodiments, storing the contact information of the user includes storing, via the processor, the contact information of the user as one of a telephone number and an email address. In some of these embodiments, the method of using a server device is additionally for use with a wireless network, wherein the client device is configured to communicate with the wireless network based on the telephone number, wherein storing the contact information includes storing, via the processor, the contact information of the user as the telephone number, and wherein the automatically transmitting the message instruction includes automatically transmitting, via the processor, the message instruction to the client device by way of the wireless network. In some further embodiments, the client device is configured to receive the message instruction based on the email address, wherein the storing the contact information includes storing, via the processor, the contact information of the user as an email address, and wherein the automatically transmitting the message instruction includes automatically transmitting, via the processor, the message instruction to the client device using the email address.

In some further embodiments, the method of using a server device further including automatically transmitting, via the processor, a second reconfigure instruction to the CMTS to instruct the CMTS to cease providing the LLD service flow to the cable modem after expiration of the predetermined period of time.

Other aspects of the present disclosure are drawn to a non-transitory, computer-readable media having computer-readable instructions stored thereon, the computer-readable instructions being capable of being read by a server device for use with a service provider device, a service receiving device, a provisioning system, a client device, and a user. The service provider device is configured to provide a service flow to the service receiving device and is configured to provide a low latency service flow to the service receiving device. The low latency service flow has a latency that is lower than that of the service flow. The provisioning system is configured to provision the service receiving device to receive the service flow or the low latency service flow. The client device is configured to operate an application for use by the user and to provide upstream application data based on the application to the service provider device via the service receiving device and to receive downstream application data based on the application from the service provider device via the service receiving device. The computer-readable instructions are capable of instructing the server device to perform the method including: obtaining, via a processor, monitored data based on at least one of the upstream application data and the downstream application data; obtaining, via the processor, a comparison of the monitored data to a low latency data threshold; automatically transmitting, via the processor, a reconfigure instruction to the service provider device to instruct the service provider device to provide the low latency service flow to the service receiving device for a predetermined period of time and based on the comparison or to the provisioning system to instruct the provisioning system to cause the service provider device to provide the low latency service flow to the service receiving device for a predetermined period of time and based on the comparison; and automatically transmitting, via the processor, a message instruction to instruct the user of the low latency service flow and based on the predetermined period of time.

In some embodiments, the non-transitory, computer-readable media, is for use with a cable modem termination system (CMTS) as the service provider device, and a cable modem as the service receiving device. The CMTS is configured to provide the service flow as a data over cable service interface specifications (DOCSIS) service flow to the cable modem and is configured to provide the low latency service flow as a low latency DOCSIS (LLD) service flow to the cable modem. The computer-readable instructions are capable of instructing the server device to perform the method, wherein the obtaining the comparison includes obtaining the comparison as a second comparison of the at least one of the upstream application data and the downstream application data to the low latency data threshold; wherein the automatically transmitting the reconfigure instruction includes automatically transmitting the reconfigure instruction to the CMTS to instruct the CMTS to provide the LLD service flow to the cable modem for a predetermined period of time and based on the second comparison or automatically transmitting the reconfigure instructions to the provisioning system to instruct the provisioning system to cause the CMTS to provide the LLD service flow to the cable modem for a predetermined period of time and based on the second comparison, and wherein the automatically transmitting the message instruction includes automatically transmitting the message instruction to instruct the user of the LLD service flow and based on the predetermined period of time.

In some further embodiments, the computer-readable instructions are capable of instructing the server device to perform the method further including: storing, via the processor and into a memory, an association between the cable modem and the user; and storing, via the processor and into the memory, contact information of the user. In some of these embodiments, the computer-readable instructions are capable of instructing the server device to perform the method wherein the storing the contact information of the user includes storing, via the processor, the contact information of the user as one of a telephone number and an email address. In some of these embodiments, the server device is additionally for use with a wireless network and the client device is configured to communicate with the wireless network based on the telephone number, wherein the computer-readable instructions are capable of instructing the server device to perform the method wherein the storing the contact information includes storing, via the processor, the contact information of the user as the telephone number, and wherein the automatically transmitting the message instruction includes automatically transmitting, via the processor, the message instruction to the client device by way of the wireless network. In some further embodiments, the client device is configured to receive the message instruction based on the email address, wherein the computer-readable instructions are capable of instructing the server device to perform the method wherein the storing the contact information includes storing, via the processor, the contact information of the user as an email address, and wherein the automatically transmitting the message instruction includes automatically transmitting, via the processor, the message instruction to the client device using the email address.

In some further embodiments, the computer-readable instructions are capable of instructing the server device to perform the method further including automatically transmitting, via the processor, a second reconfigure instruction to the CMTS to instruct the CMTS to cease providing the LLD service flow to the cable modem after expiration of the predetermined period of time.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates an algorithm to be executed by a processor to enable a service provider device to provide LLD to a cable modem in accordance with aspects of the present disclosure;

FIG. 2A illustrates a communication system at time t₀;

FIG. 2B illustrates a communication system at time t₁;

FIG. 2C illustrates a communication system at time t₂; and

FIG. 3 illustrates an exploded view of a client device, a cable modem, and a router.

### DETAILED DESCRIPTION

Many internet users lack extensive knowledge about the internet for which they have access. Therefore, it can be difficult to convince these users to upgrade their internet services using specific terminology, such as lowering latency. Low latency describes a computer network that is optimized to process a very high volume of data messages with minimal delay (latency). These networks are designed to support operations that require near real-time access to rapidly changing data. Low latency is desirable in a wide range of use cases. In a general sense, lower latency is nearly always an improvement over slower packet transport. Low latency is desirable in online gaming as it contributes to a more realistic gaming environment. However, the term low latency is most often used to describe specific business use cases, in particular high-frequency trading in capital markets.

For some applications that require internet, a non-limiting example of which is online gaming, having low latency will drastically improve user experience. As such, an efficient way to convince these users of the benefits of upgrading their internet by lowering their latency is providing them with a free trial. After users experience the difference of having low latency services, they will be more likely to upgrade.

What is needed is a system and method for providing a low latency service trial with intent to have users upgrade permanently.

A system and method in accordance with the present disclosure provides a low latency service trial with a mechanism to automatically contact an end user regarding permanently upgrading the low latency service.

In accordance with the present disclosure, data associated with internet applications being used by users in a household are monitored. In some cases, this data may be monitored by a cable modem within a household. In some cases, this data may be monitored by a cable modem termination system (CMTS) that provides the service flow to the cable modem. In some cases, this data may be monitored by a low latency controller that may be separate from both the cable modem and the CMTS.

The user may have a user account stored in a database that associates the user with the cable modem and with user identifying information, such as a phone number or email address.

The monitored data, or more specifically headers of the packets of the data, are then analyzed to determine if they meet a predetermined a low latency data threshold. In a non-limiting example embodiment, the CMTS provides a Data Over Cable Service Interface Specification (DOCSIS) service flow to the cable modem. A client device, such as a computer or smart phone, may access the internet via the cable modem using the DOSCIS service flow.

A data structure, such as a low latency look-up table (LUT), may have a priori data stored therein, wherein the a priori data identifies server addresses that are associated with applications that may run on a client device that may benefit from low latency. Non-limiting examples of such servers include online video game servers or stock trading servers. In some embodiments, this low latency LUT may reside in a low latency DOCSIS (LLD) controller. In some embodiments, this low latency LUT may reside in the CMTS. In some embodiments, this low latency LUT may reside in the cable modem.

Each packet to/from the cable modem will have data within its packet header to identify the address of the external server from which the packet originated, when traveling in a downstream service flow to the cable modem (and ultimately to the client device) or to which the packet is destined, when traveling in an upstream service flow from the cable modem (and originally from the client device).

In embodiments wherein the low latency LUT resides in the LLD controller, the LLD controller may analyze packets and compare the address of the external server with the a priori data within the low latency LUT. In embodiments wherein the low latency LUT resides in the CMTS, the CMTS may analyze packets and compare the address of the external server with the a priori data within the low latency LUT. In embodiments wherein the low latency LUT resides in the cable modem, the cable modem may analyze packets and compare the address of the external server with the a priori data within the low latency LUT.

If the identified packets match any addresses in the low latency LUT, then the packets correspond to an application that may benefit from a low latency service flow, which in this case would be a low latency DOCSIS (LLD) service flow.

In some embodiments, the mere existence of a single data packet that would qualify for a LLD service flow may meet the predetermined threshold. In some embodiments, a predetermined number of packets to/from the cable modem that would qualify for a LLD service flow may meet the predetermined threshold. In some embodiments, a predetermined number of packets to/from the cable modem, from a predetermined number of difference client devices that would qualify for a LLD service flow may meet the predetermined threshold.

In embodiments wherein the low latency LUT resides in the cable modem, and if an application's monitored data meets the predetermined threshold, the cable modem will instruct the LLD controller to automatically instruct the CMTS to enable a low latency service flow to the cable modem for a predetermined trial period.

In embodiments wherein the low latency LUT resides in the CMTS, and if an application's monitored data meets the predetermined threshold, the CMTS will instruct the LLD controller to automatically instruct the CMTS to enable a low latency service flow to the cable modem for a predetermined trial period.

In embodiments wherein the low latency LUT resides in the LLD controller, and if an application's monitored data meets the predetermined threshold, the LLD controller will automatically instruct the CMTS to enable a low latency service flow to the cable modem for a predetermined trial period.

The affected users will be notified of the low latency service flow upgrade. In some embodiments, the LLD controller automatically transmits a notification to the user via the CMTS to the cable modem, which then contacts the client device of the user. In some embodiments, the LLD controller automatically transmits the notification to the user via a cellular network by way of the user's client device. The user will have an opportunity to upgrade to the low latency service flow permanently after the predetermined trial period has ended.

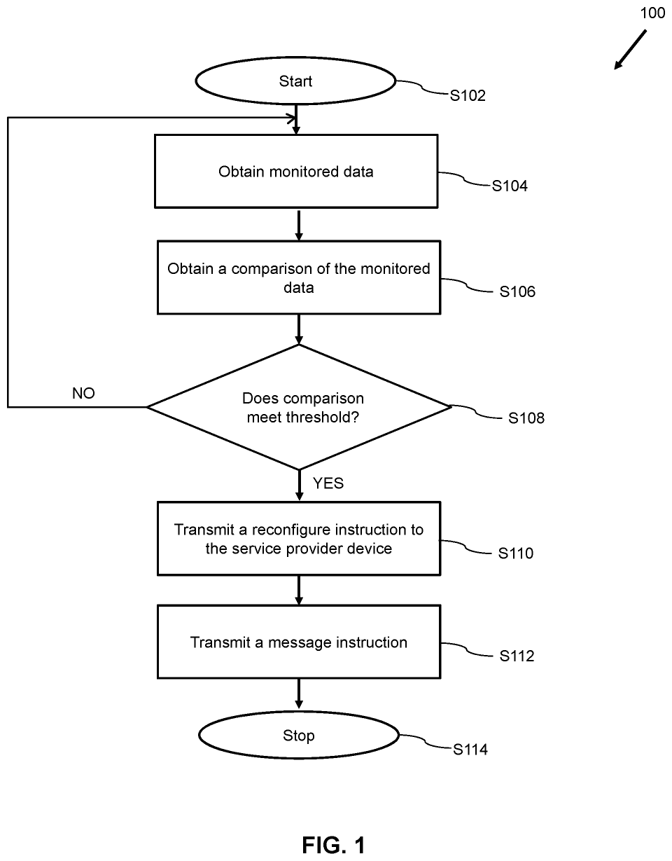

An example system and method for automatically providing a low latency service flow trial in accordance with aspects of the present disclosure will now be described in greater detail with reference to FIGS. 1-3.

FIG. 1 illustrates algorithm 100 to be executed by a processor to enable a service provider device to provide LLD to a cable modem in accordance with aspects of the present disclosure.

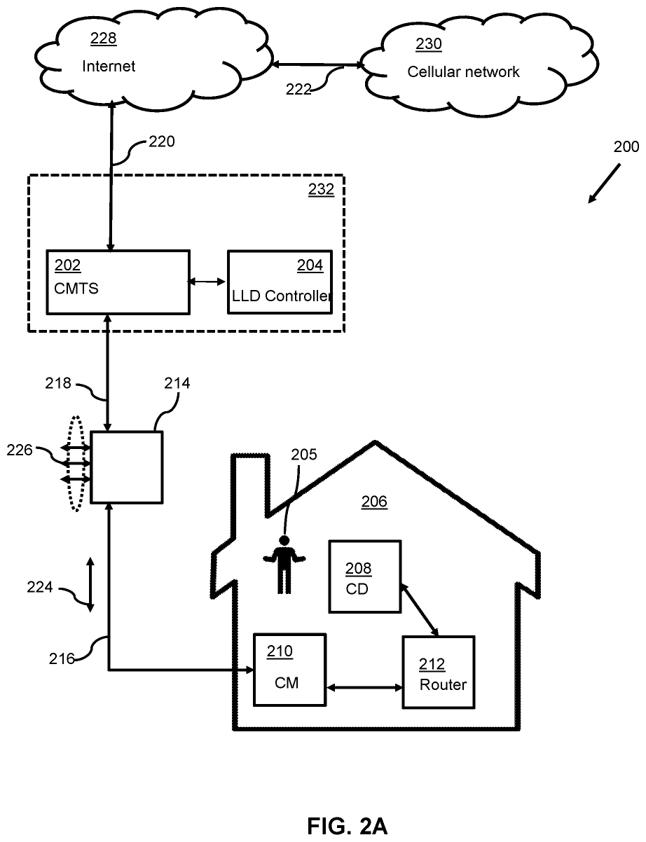

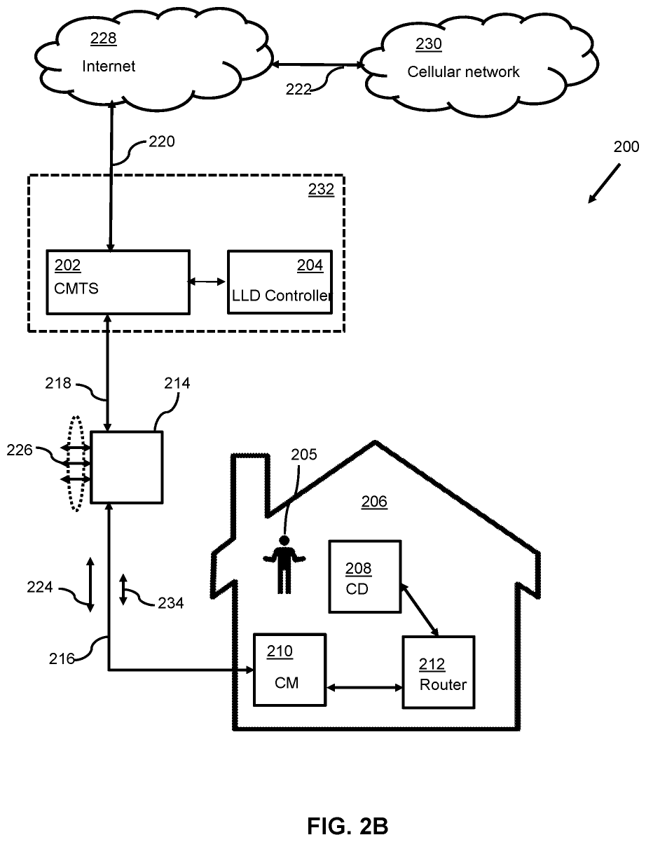

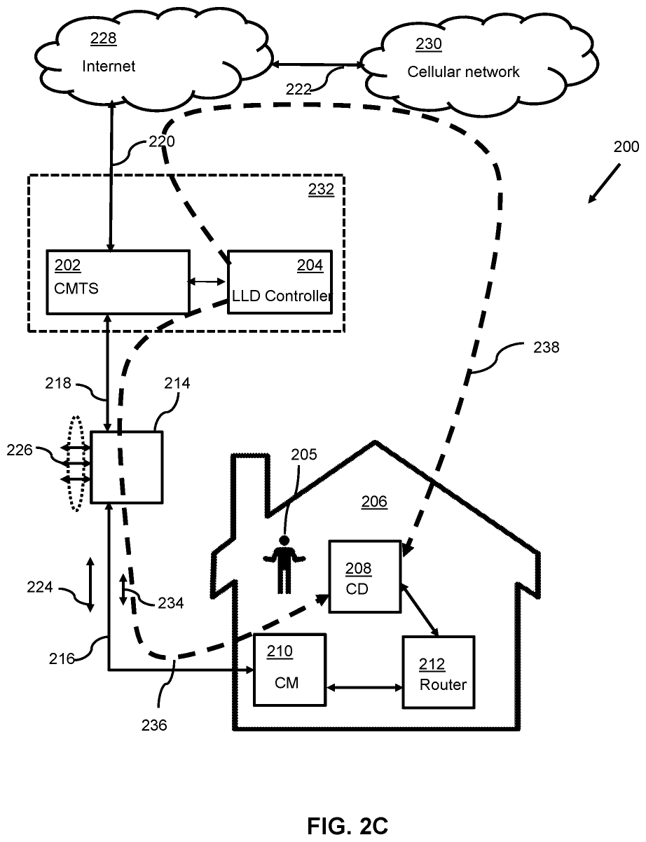

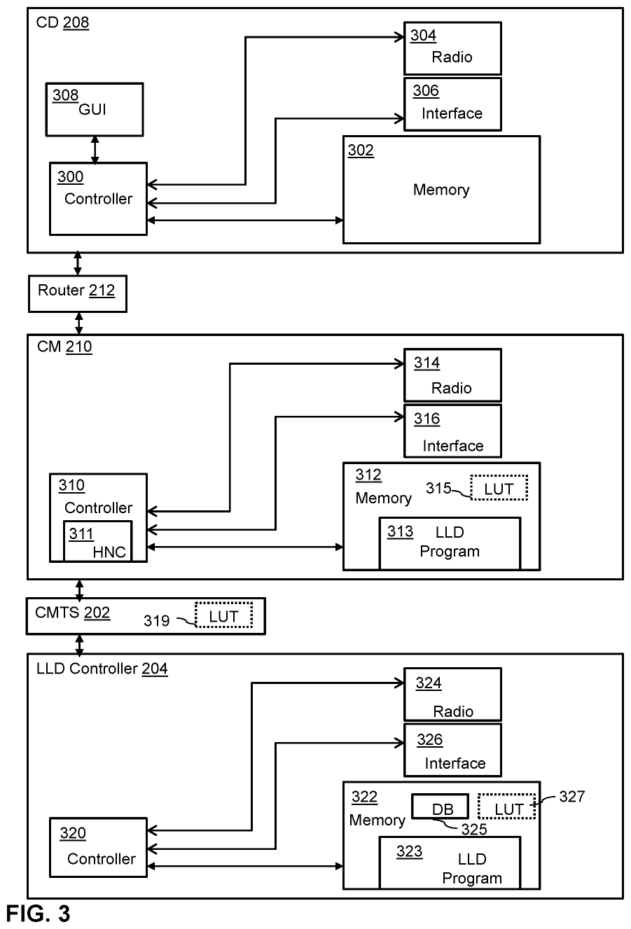

As shown in FIG. 1, algorithm 100 starts (S102) and the monitored data is obtained (S104). This will be discussed in greater detail with reference to FIGS. 2A and 3.

FIG. 2A illustrates a communication system 200 at time t₀.

As shown in FIG. 2A, communication system 200 includes a CMTS 202, a LLD controller 204, a user 205, a residence 206, a client device 208, a cable modem 210, a router 212, a network node 214, communication channels 216, 218, 220, and 222, a service flow 224, a plurality of service flows 226, an internet 228, and a cellular network 230. In some embodiments, CMTS 202 and LLD controller 204 will be combined into a unitary device, shown as CMTS/LLD controller 232.

Cable modem 210, or CM, is an electronic device that is to be located so as to establish a local area network (LAN) at a consumer premises. The consumer premises can include a residential dwelling, office, or any other business space of a user, such as residence 206. The terms home, office, and premises may be used synonymously herein.

Cable modem 210 may perform such functions as web acceleration and HTTP compression, flow control, encryption, redundancy switchovers, traffic restriction policy enforcement, data compression, TCP performance enhancements (e.g., TCP performance enhancing proxies, such as TCP spoofing), quality of service functions (e.g., classification, prioritization, differentiation, random early detection (RED), TCP/UDP flow control), bandwidth usage policing, dynamic load balancing, and routing.

Further, it should be noted that cable modem 210 is able to communicate with CMTS 202 via communication channels 216 and 218, which may optionally be a wireless communication system, such as 4G, or 5G, and further is able to connect to internet 228.

Gateway device 210 serves as a gateway or access point to internet 228 for one or more electronic devices, referred to generally herein as client device 208 that wirelessly communicates with gateway device 210 via, e.g., Wi-Fi. Client device 208 can be a desktop computer, laptop computer, electronic tablet device, smart phone, appliance, or any other so called internet of things equipped devices that are equipped to communicate information.

A wireless access point (WAP), or more generally just access point (AP), is a networking hardware device that allows other Wi-Fi devices to connect to a Wi-Fi network. A service set ID (SSID) is an identification (in IEEE 802.11) that is broadcast by access points in beacon packets to announce the presence of a network access point for the SSID. SSIDs are customizable IDs that can be zero to 32 bytes, and can be in a natural language, such as English. In residence 206, cable modem 210 and router 212 are access points.

CMTS 202 is used to provide high speed data services, e.g., cable internet.

CMTS 202 is configured to provide service flow 224 to cable modem 210 as a data over cable service interface specifications (DOCSIS) service flow. DOCSIS is a globally recognized telecommunications standard that enables high-bandwidth data transfer via existing coaxial cable systems that were originally user in the transmission of cable television program signals.

In some embodiments, as opposed to a DOCSIS environment, a passive optical network (PON) may be similarly implemented in accordance with aspects of the present disclosure, wherein the PON service provider would provide a regular latency service flow and a low latency service flow. A PON is a fiber-optic telecommunications technology for delivering broadband network access.

FIG. 3 illustrates an exploded view of client device 208, cable modem 210, and router 212.

As shown in FIG. 3, client device 208 includes a controller 300; a memory 302, which has stored therein a LLD program 303; and at least one radio, a sample of which is illustrated as a radio 304; an interface 306; and a graphic user interface (GUI) 308.

In this example, controller 300, memory 302, radio 304, interface 306 and GUI 308 are illustrated as individual devices. However, in some embodiments, at least two of controller 300, memory 302, radio 304, interface 306 and GUI 308 may be combined as a unitary device. Further, in some embodiments, at least one of controller 300 and memory 302 may be implemented as a computer having tangible computer-readable media for carrying or having computer-executable instructions or data structures stored thereon.

Controller 300 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of client device 208 in accordance with the embodiments described in the present disclosure.

Memory 302 can store various programming, and user content, and data.

Radio 304, may include a Wi-Fi WLAN interface radio transceiver that is operable to communicate with router 212, as shown in FIG. 2A-C and also may include a cellular transceiver operable to communicate with cellular network 230. Radio 304 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Client device 208 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Interface 306 can include one or more connectors, such as RF connectors, or Ethernet connectors, and/or wireless communication circuitry, such as 5G circuitry and one or more antennas.

GUI 308 may be any known device or system to display an interactive image to enable a user to interact with client device 208.

As shown in FIG. 3, cable modem 210 includes a controller 310; a home network controller (HNC) 311; memory 312, which has stored therein a LLD program 313 and in some embodiments may optionally include a low latency LUT 315; at least one radio, a sample of which is illustrated as a radio 314; and an interface 316.

In this example, controller 310, memory 312, radio 314, and interface 316 are illustrated as individual devices. However, in some embodiments, at least two of controller 310, memory 312, radio 314, and interface 316 may be combined as a unitary device. Further, in some embodiments, at least one of controller 310 and memory 312 may be implemented as a computer having tangible computer-readable media for carrying or having computer-executable instructions or data structures stored thereon.

Controller 310 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of cable modem 210 in accordance with the embodiments described in the present disclosure.

HNC 311 controls cable modem 210 within the wireless network. HNC 311 may perform tasks such as steering connected devices, a non-limiting example of which is a cell phone, from one access point to another.

Memory 312 can store various programming, and user content, and data, including LLD program 313.

LLD program 313 includes instructions to be executed by controller 310 to cause cable modem 210 to divert regular latency traffic to service flow 224 and divert low latency traffic to LLD service flow 234, as shown in FIG. 2B.

In some embodiments, LLD program 313 additionally includes instructions to be executed by controller 310 to cause cable modem 210 to provision service flow 224 and LLD service flow 234 with CMTS 202. In this sense, in some embodiments, cable modem 210 acts as provisioning system.

Radio 314, may include a Wi-Fi WLAN interface radio transceiver that is operable to communicate with router 212 and CMTS 202, as shown in FIG. 2A-C. Radio 314 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Radio 314 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Interface 316 can include one or more connectors, such as RF connectors, or Ethernet connectors, and/or wireless communication circuitry, such as 5G circuitry and one or more antennas. Interface 316 receives data from CMTS 202 (as shown in FIG. 2A) by known methods, non-limiting examples of which include terrestrial antenna, satellite dish, wired cable, DSL, optical fibers, or 5G as discussed above.

In some embodiments CMTS 202 may optionally include a low latency LUT 319.

LLD controller 204 includes a controller 320; a memory 322, which has stored therein an LLD program 323 and a user database 325, and in some embodiments may optionally include a low latency LUT 327; and at least one radio, a sample of which is illustrated as a radio 324; and an interface 326.

In this example, controller 320, memory 322, radio 324, and interface 326 are illustrated as individual devices. However, in some embodiments, at least two of controller 320, memory 322, radio 324, and interface 326 may be combined as a unitary device. Further, in some embodiments, at least one of controller 320 and memory 322 may be implemented as a computer having tangible computer-readable media for carrying or having computer-executable instructions or data structures stored thereon.

Controller 320 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of LLD controller 204 in accordance with the embodiments described in the present disclosure.

Memory 322, as will be described in greater detail below, has instructions, including LLD program 323, stored therein to be executed by controller 320 to allow LLD controller 204 to: obtain monitored data based on at least one of the upstream application data and the downstream application data; obtain a comparison of the monitored data to a low latency data threshold; automatically transmit a reconfigure instruction to CMTS 202 to instruct the CMTS 202 to provide the low latency service flow to cable modem 210 for a predetermined period of time and based on the comparison or to the provisioning system to instruct the provisioning system to cause CMTS 202 to provide the low latency service flow to cable modem 210 for a predetermined period of time and based on the comparison; and automatically transmit a message instruction to instruct user 205 of the low latency service flow and based on the predetermined period of time.

In some embodiments, memory 322, as will be described in greater detail below, has additional instructions within LLD program 323 to be executed by controller 320 to allow LLD controller 204 to: obtain the comparison as a second comparison of the at least one of the upstream application data and the downstream application data to the low latency data threshold; automatically transmit the reconfigure instruction by automatically transmitting the reconfigure instruction to CMTS 202 to instruct CMTS 202 to provide the LLD service flow to cable modem 210 for a predetermined period of time and based on the second comparison or automatically transmitting the reconfigure instruction to the provisioning system to instruct the provisioning system to cause CMTS 202 to provide the LLD service flow to cable modem 210 for a predetermined period of time and based on the second comparison; and automatically transmit the message instruction by automatically transmitting the message instruction to instruct user 205 of the LLD service flow and based on the predetermined period of time.

In some embodiments, memory 322, as will be described in greater detail below, has additional instructions within LLD program 323 to be executed by controller 320 to allow LLD controller 204 to: store, into memory 322, an association between cable modem 210 and user 205; and store, into memory 322, contact information of user 205.

In some embodiments, memory 322, as will be described in greater detail below, has additional instructions within LLD program 323 to be executed by controller 320 to allow LLD controller 204 to: store the contact information of user 205 as one of a telephone number and an email address.

In some embodiments, memory 322, as will be described in greater detail below, has additional instructions within LLD program 323 to be executed by controller 320 to allow LLD controller 204 to: store the contact information of user 205 as the telephone number; and automatically transmit the message instruction to client device 208 by way of cellular network 230.

In some embodiments, memory 322, as will be described in greater detail below, has additional instructions within LLD program 323 to be executed by controller 320 to allow LLD controller 204 to: store the contact information of user 205 as an email address; and automatically transmit the message instruction to client device 208 using the email address.

In some embodiments, memory 322, as will be described in greater detail below, has additional instructions within LLD program 323 to be executed by controller 320 to allow LLD controller 204 to: automatically transmit a second reconfigure instruction to CMTS 202 to instruct CMTS 202 to cease providing the LLD service flow to cable modem 210 after expiration of the predetermined period of time.

Database 325 includes registered user data associated with a registered user. For example, a person may register with CMTS 202 to receive cable service. Once registered, contact information of that person, such as the physical address, a phone number or email address, may be added to database 325. Further, each network device associated with either the person or the physical address may also be included in database 325. For example, as shown in FIG. 2, the physical address of residence 206 may be included in database 325. Further, identification data of cable modem 210, such as make, model, serial number and identification data of router 212 may be associated with at least one of user 205 and residence 206 and included in database 325. Further, identification data of client device 208, such as make, model, serial number may be associated with at least one of user 205 and residence 206 and included in database 325.

Radio 324, may include a Wi-Fi WLAN interface radio transceiver that is operable to communicate with CMTS 204 and also may include a cellular transceiver operable to communicate with cellular network 230, as shown in FIG. 2A-C. Radio 324 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Radio 324 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Interface 326 can include one or more connectors, such as RF connectors, or Ethernet connectors, and/or wireless communication circuitry, such as 5G circuitry and one or more antennas. Interface 326 receives data from cable modem 210 (as shown in FIG. 2A) by known methods, non-limiting examples of which include terrestrial antenna, satellite dish, wired cable, DSL, optical fibers, or 5G as discussed above. Through interface 326, external server 214 receives an input signal, including data and/or audio/video content, from gateway device 210 and can send data to cable modem 210.

As will be described in more detail below, in some embodiments, in some embodiments, cable modem 210 obtains the monitored data, wherein cable modem 210 monitors the data packets to/from cable modem 210 to determine the address of the server to which cable modem 210 is communicating.

As will be described in more detail below, alternatively in some embodiments, in some embodiments, CMTS 202 obtains the monitored data, wherein CMTS 202 monitors the data packets to/from cable modem 210 to determine the address of the server to which cable modem 210 is communicating.

As will be described in more detail below, alternatively in some embodiments, in some embodiments, LLD controller 204 obtains the monitored data, wherein LLD controller 204 monitors the data packets to/from cable modem 210 to determine the address of the server to which cable modem 210 is communicating.

In operation, with reference to FIG. 2A, presume that user 205 of residence 206 is playing a multiplayer video game on client device 208. For purposes of discussion only, in this non-limiting example embodiment, cable modem 210 may monitor the upstream data packets being sent from client device 208 to CMTS 202, and the downstream data packets being sent from CMTS 202 to client device 208. Cable modem 210 may determine whether any of the upstream or downstream data packets qualify as packets that may benefit from a LLD service flow. In particular, cable modem 210 may monitor the upstream data packets being sent to and from client device 208 to determine the address of external server for which client device 208 is communicating. Cable modem 210 may then compared this address of the external server with a priori data contained within low latency LUT 315 in memory 312. The a priori data within low latency LUT 315 contains server addresses of online applications wherein any packets sent to or from the server will qualify as traffic that will benefit from a LLD service flow. In this example, as the multiplayer video game application data packets are associated with a priori data within low latency LUT 315, cable modem 210 will determine that the multiplayer video game is eligible to receive a LLD service flow.

There are multiple events which may occur to determine if an application is eligible for a LLD service flow, non-limiting examples of which include: the presence of a single data packet associated with an eligible application of the low latency LUT; the accumulation of multiple data packets associated with an eligible application of the low latency LUT exceeding a predetermined threshold, e.g., a single client device using an application for a predetermined period of time; and the accumulation of multiple packets from multiple different applications associated with an eligible application of the low latency LUT, e.g., a predetermined number of different client devices using respective applications.

It should be noted, as mentioned above, that in some embodiments, CMTS 202 may alternatively monitor the upstream data packets being sent from client device 208 to CMTS 202, and the downstream data packets being sent from CMTS 202 to client device 208 to determine whether such packets may benefit from a low latency service flow. In those embodiments, CMTS 202 may then compared this address of the external server with a priori data contained within low latency LUT 319 to determine that the multiplayer video game is eligible to receive a LLD service flow in a manner similar to the embodiment discussed above wherein cable modem 210 is making such a determination.

It should be further noted, as mentioned above, that in some embodiments, LLD controller 204 may alternatively monitor the upstream data packets being sent from client device 208 to CMTS 202, and the downstream data packets being sent from CMTS 202 to client device 208 to determine whether such packets may benefit from a low latency service flow. In those embodiments, LLD controller 204 may then compared this address of the external server with a priori data contained within low latency LUT 327 to determine that the multiplayer video game is eligible to receive a LLD service flow in a manner similar to the embodiment discussed above wherein cable modem 210 is making such a determination.

For purposes of discussion, consider the embodiment wherein cable modem 210 is monitoring the data to determine whether there may be a benefit from a low latency service flow. In such a situation, radio 304 of client device 208 will upload multiplayer video game data packets through router 212 to radio 314 of cable modem 210. Similarly, CMTS 202 will download multiplayer video game data packets to interface 316 of cable modem 210. Controller 310 will execute instructions stored on memory 312 to cause cable modem 210 to monitor the multiplayer video game data packets and find that the multiplayer video game data packets are associated with a priori data within low latency LUT of memory 312.

In some embodiments, CMTS 202 and LLD controller 204 will be a unitary device, depicted as CMTS/LLD controller 232. As such, cable modem 210 would upload data packets from client device 208 to CMTS/LLD controller 232, and download data packets from CMTS/LLD controller 232 to client device 208.

Returning to FIG. 1, after the monitored data is obtained (S104), a comparison of the monitored data is obtained (S106). In some embodiments, the comparison may be performed by cable modem 210. In some embodiments, the comparison may be performed by CMTS 202. In some embodiments, the comparison may be performed by LLD controller 204.

For example, presume that cable modem 210 will observe the upstream and downstream data packets of the multiplayer video game application associated with client device 208, and compare the packets to a previously determined threshold. In this instance, presume that the threshold is the existence of at least one data packet associated with an eligible application of the low latency LUT. Controller 310 will execute instructions stored on memory 312 to cause cable modem 210 to compare the data packets of the multiplayer video game application to the single data packet threshold.

In some embodiments, CMTS 202 will observe the upstream and downstream data packets of the multiplayer video game application associated with client device 208, and compare the packets to a previously determined threshold. CMTS 202 will operate in a similar manner to cable modem 210, and compare the data packets of the multiplayer video game application to the single data packet threshold.

In some embodiments, LLD controller 204 will observe the upstream and downstream data packets of the multiplayer video game application associated with client device 208, and compare the packets to a previously determined threshold. Controller 320 will execute instructions stored on memory 322 to cause cable modem LLD controller 204 to compare the data packets of the multiplayer video game application to the single data packet threshold.

Returning to FIG. 1, after the comparison of the monitored data is obtained (S106), it is determined whether the comparison meets a threshold (S108). In some embodiments, cable modem 210 may determine whether the comparison meets a threshold. In some other embodiments, CMTS 202 may alternatively determine whether the comparison meets a threshold. In yet some other embodiments, LLD controller 204 may alternatively determine whether the comparison meets a threshold.

Accordingly, there are multiple possible embodiments in accordance with aspects of the present disclosure, non-limiting examples of which include: embodiments wherein cable modem 210 monitors the upstream and downstream data packets, and cable modem 210 determines whether the comparison meets a threshold; embodiments wherein CMTS 202 monitors the upstream and downstream data packets, and cable modem 210 determines whether the comparison meets a threshold; embodiments wherein LLD controller 204 monitors the upstream and downstream data packets, and cable modem 210 determines whether the comparison meets a threshold; embodiments wherein cable modem 210 monitors the upstream and downstream data packets, and CMTS 202 determines whether the comparison meets a threshold; embodiments wherein CMTS 202 monitors the upstream and downstream data packets, and CMTS 202 determines whether the comparison meets a threshold; embodiments wherein LLD controller 204 monitors the upstream and downstream data packets, and CMTS 202 determines whether the comparison meets a threshold; embodiments wherein cable modem 210 monitors the upstream and downstream data packets, and LLD controller 204 determines whether the comparison meets a threshold; embodiments wherein CMTS 202 monitors the upstream and downstream data packets, and LLD controller 204 determines whether the comparison meets a threshold; and embodiments wherein LLD controller 204 monitors the upstream and downstream data packets, and LLD controller determines whether the comparison meets a threshold.

For purposes of discussion only, consider the embodiment wherein data packets of the multiplayer video game application associated with client device 208 are monitored. As mentioned above, this process may be performed, based on the embodiment, by either cable modem 210, CMTS 202, or LLD controller 204. Further, and for purposes of discussion only, consider the example situation wherein the threshold is the presence of a single data packet associated with an eligible application of low latency LUT. In this case, it may be determined whether the multiplayer video game application has met the data threshold is there is a presence of a single packet. In some embodiments, this determination may be performed by cable modem 210. In some embodiments, this determination may be performed by CMTS 202. In some embodiments, this determination may be performed by LLD controller 204.

As cable modem 210 has found at least one data packet associated with the multiplayer video game application, cable modem 210 will determine that the application associated with client device 208 is an application that is eligible for low latency service. Once the determination is made (YES at S108), LLD controller 204 will instruct CMTS 202 to provide a low latency service flow to cable modem 210.

Returning to FIG. 1, if it is determined that the comparison does not meet the threshold (N at S108), then algorithm 100 restarts (Return to S102). For example, presume that user 205 is playing a multiplayer video game on client device 208. Cable modem 210 monitors the data packets associated with the multiplayer video game application. Further, the data threshold is the accumulation of multiple data packets associated with an eligible application of low latency LUT exceeding a predetermined value. While cable modem 210 has monitored the data packets of the multiplayer video game application, there have not been enough data packets to break the data threshold. As such, cable modem 210 is not in need of a LLD service flow, and will continue to monitor the data packets until their number exceeds the data threshold.

Returning to FIG. 1, if it is determined that the comparison is greater than the threshold (Y at S108), then a reconfigure instruction is transmitted to the service provider device (S110). This will be described in greater detail with reference to FIG. 2B.

FIG. 2B illustrates communication system 200 at time t₁.

As shown in FIG. 2B, communication system 200 includes CMTS 202, LLD controller 204, user 205, residence 206, client device 208, cable modem 210, router 212, network node 214, communication channels 216, 218, 220, and 222, service flow 224, plurality of service flows 226, internet 228, cellular network 230, CMTS/LLD controller 232, and an LLD service flow 234.

CMTS 202 is configured to provide LLD service flow to cable modem 210 as a low latency DOCSIS service flow.

For example, with reference to FIG. 2B, presume that cable modem 210 has found that the multiplayer video game data packets has exceeded the data threshold, the threshold in this case being the is the presence of a single data packet associated with an eligible application of low latency LUT. Controller 310 will execute instructions stored on memory 312 causing cable modem 210 to transmit an instruction to LLD controller 204. LLD controller 204 will then instruct CMTS 202 to provide LLD service flow 234 to cable modem 210, as shown in FIG. 3.

In some embodiments, where cable modem 210 monitors the data packets, cable modem 210 will also determine if the predetermined data threshold has been met by the data packets. In some further embodiments, where cable modem 210 monitors the data packets, CMTS 202 will determine if the predetermined data threshold has been met by the data packets. LLD controller 204 will be notified to instruct CMTS 202 to provide LLD service flow 234 to cable modem 210 when the data threshold is met. In some further embodiments, where cable modem 210 monitors the data packets, LLD controller 204 will determine if the predetermined data threshold has been met by the data packets. LLD controller 204 will directly instruct CMTS 202 to provide LLD service flow 234 to cable modem 210 when the data threshold is met.

In some embodiments, where CMTS 202 monitors the data packets, CMTS 202 will also determine if the predetermined data threshold has been met by the data packets. In some further embodiments, where CMTS 202 monitors the data packets, cable modem 210 will determine if the predetermined data threshold has been met by the data packets. LLD controller 204 will be notified to instruct CMTS 202 to provide LLD service flow 234 to cable modem 210 when the data threshold is met. In some further embodiments, where CMTS 202 monitors the data packets, LLD controller 204 will determine if the predetermined data threshold has been met by the data packets. LLD controller 204 will directly instruct CMTS 202 to provide LLD service flow 234 to cable modem 210 when the data threshold is met.

In some embodiments, where LLD controller 204 monitors the data packets, LLD controller 204 will also determine if the predetermined data threshold has been met by the data packets. In some further embodiments, where LLD controller 204 monitors the data packets, cable modem 210 will determine if the predetermined data threshold has been met by the data packets. LLD controller 204 will be notified to instruct CMTS 202 to provide LLD service flow 234 to cable modem 210 when the data threshold is met. In some further embodiments, where LLD controller 204 monitors the data packets, CMTS 202 will determine if the predetermined data threshold has been met by the data packets. LLD controller 204 will be notified to instruct CMTS 202 to provide LLD service flow 234 to cable modem 210 when the data threshold is met.

In some embodiments, only one of the upstream data or the downstream data will be greater than the data threshold. So long as at least one of the upstream data or the downstream data are greater than the data threshold, CMTS 202 will provide LLD service flow 234 to cable modem 210.

In some embodiments, at least one of the upstream data or the downstream data will be greater than the data threshold. However, the application may not have a priori data in low latency LUT, meaning that the application is not an application eligible for LLD service. In such a case, a low latency service flow will not be provided to cable modem 210.

Returning to FIG. 1, after a reconfigure instruction is transmitted to the service provider device (S110), a message instruction is transmitted (S112). This will be described in greater detail with reference to FIG. 2C.

FIG. 2C illustrates communication system 200 at time t₂.

As shown in FIG. 2C, communication system 200 includes CMTS 202, LLD controller 204, user 205, residence 206, client device 208, cable modem 210, router 212, network node 214, communication channels 216, 218, 220, and 222, service flow 224, plurality of service flows 226, internet 228, cellular network 230, CMTS/LLD controller 232, LLD service flow 234, and message instructions 236 and 238.

For example, with reference to FIG. 2C, presume that CMTS 202 was instructed by LLD controller 204 to provide LLD service flow 234 to cable modem 210. Client device 208 will then receive message instruction 236 from LLD controller 204 through CMTS 202, communication channel 218, network node 214, communication channel 216, cable modem 210, and router 212. With reference to FIG. 3, controller 300 of client device 208 will execute instructions stored on memory 302 which causes client device 208 to display a notification on GUI 308. User 205, operating client device 208, will see the notification which notifies user 205 of the temporary trial period of CMTS 202 providing LLD service flow 234, a non-limiting example of which is one month.

In some embodiments, client device 208 may receive message instruction 238 from LLD controller 204 through cellular network 230. Client device 208 may provide a notification to user 205 in a similar manner to that described above.

Returning to FIG. 1, after a message instruction is transmitted (S112), algorithm 100 stops (S114).

In some embodiments, if user 205 has not purchased a subscription after the predetermined temporary trial period is over, LLD service flow 234 may be terminated. User 205 will be notified of the termination of the temporary trial period.

In some embodiments, user 205 may receive a notification before the temporary trial period is over.

In some embodiments, user 205 may be charged and their trial period may become permanent until user 205 cancels the subscription.

It can be difficult to convince non-tech savvy users to upgrade their internet services using specific terminology, such as lowering latency. For some applications that require internet, a non-limiting example of which is online gaming, having low latency will drastically improve user experience. The best way to convince these users of the benefits of lower their latency is providing them with a free low latency service trial. After users experience the difference of having low latency services, they will be more likely to subscribe permanently.

A user will be using an application on a client device connected to a cable modem. Upstream and downstream data of internet applications will be monitored, and eventually transferred to a LLD controller. The LLD controller will compare the upstream and downstream data to a low latency data threshold. If the upstream and downstream data meet the low latency data threshold, a temporary low latency service flow will be automatically provided by the cable modem's respective CMTS to the cable modem. The user will be notified of the change, and they will have a chance to subscribe once the temporary low latency service flow expires.

Thus, the present disclosure as disclosed automatically provides users with a low latency service flow trial to persuade users to upgrade permanently.

The operations disclosed herein may constitute algorithms that can be affected by software, applications (apps, or mobile apps), or computer programs. The software, applications, computer programs can be stored on a non-transitory computer-readable medium for causing a computer, such as the one or more processors, to execute the operations described herein and shown in the drawing figures.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A server device for use with a service provider device, a service receiving device, a provisioning system, a client device, and a user, the service provider device being configured to provide a service flow to the service receiving device and being configured to provide a low latency service flow to the service receiving device, the low latency service flow having a latency that is lower than that of the service flow, the provisioning system being configured to provision the service receiving device to receive the service flow or the low latency service flow, the client device being configured to operate an application for use by the user and to provide upstream application data based on the application to the service provider device via the service receiving device and to receive downstream application data based on the application from the service provider device via the service receiving device, said server device comprising:
a memory having instructions stored therein; and
a processor configured to execute the instructions stored on said memory to cause said server device to:
obtain monitored data based on at least one of the upstream application data and the downstream application data;
obtain a comparison of the monitored data to a low latency data threshold;
automatically transmit a reconfigure instruction to the service provider device to instruct the service provider device to provide the low latency service flow to the service receiving device for a predetermined period of time and based on the comparison or to the provisioning system to instruct the provisioning system to cause the service provider device to provide the low latency service flow to the service receiving device for a predetermined period of time and based on the comparison; and
automatically transmit a message instruction to instruct the user of the low latency service flow and based on the predetermined period of time.

2. A server device of claim 1, for use with a cable modem termination system (CMTS) as the service provider device, a cable modem as the service receiving device, the CMTS being configured to provide the service flow as a data over cable service interface specifications (DOCSIS) service flow to the cable modem and being configured to provide the low latency service flow as a low latency DOCSIS (LLD) service flow to the cable modem, wherein said processor is configured to execute the instructions stored on said memory to further cause said server device to:
obtain the comparison as a second comparison of the at least one of the upstream application data and the downstream application data to the low latency data threshold;
automatically transmit the reconfigure instruction by automatically transmitting the reconfigure instruction to the CMTS to instruct the CMTS to provide the LLD service flow to the cable modem for a predetermined period of time and based on the second comparison or automatically transmitting the reconfigure instruction to the provisioning system to instruct the provisioning system to cause the CMTS to provide the LLD service flow to the cable modem for a predetermined period of time and based on the second comparison; and
automatically transmit the message instruction by automatically transmitting the message instruction to instruct the user of the LLD service flow and based on the predetermined period of time.

3. The server device of claim 2, wherein said processor is further configured to execute the instructions stored on said memory to additionally cause said server device to:
store, into said memory, an association between the cable modem and the user; and
store, into said memory, contact information of the user.

4. The server device of claim 3, wherein said processor is further configured to execute the instructions stored on said memory to additionally cause said server device to store the contact information of the user as one of a telephone number and an email address.

5. The server device of claim 4 for further use with a wireless network, the client device being configured to communicate with the wireless network based on the telephone number, wherein said processor is further configured to execute the instructions stored on said memory to additionally cause said server device to:
store the contact information of the user as the telephone number; and
automatically transmit the message instruction to the client device by way of the wireless network.

6. The server device of claim 4, the client device being configured to receive the message instruction based on the email address, wherein said processor is further configured to execute the instructions stored on said memory to additionally cause said server device to:
store the contact information of the user as an email address; and
automatically transmit the message instruction to the client device using the email address.

7. The server device of claim 2, wherein said processor is further configured to execute the instructions stored on said memory to additionally cause said server device to:
automatically transmit a second reconfigure instruction to the CMTS to instruct the CMTS to cease providing the LLD service flow to the cable modem after expiration of the predetermined period of time.

8. A method of using server device with a service provider device, a service receiving device, a provisioning system, a client device, and a user, the service provider device being configured to provide a service flow to the service receiving device and being configured to provide a low latency service flow to the service receiving device, the low latency service flow having a latency that is lower than that of the service flow, the provisioning system being configured to provision the service receiving device to receive the service flow or the low latency service flow, the client device being configured to operate an application for use by the user and to provide upstream application data based on the application to the service provider device via the service receiving device and to receive downstream application data based on the application from the service provider device via the service receiving device, said method comprising:
obtaining, via a processor, monitored data based on at least one of the upstream application data and the downstream application data;
obtaining, via the processor, a comparison of the monitored data to a low latency data threshold;
automatically transmitting, via the processor, a reconfigure instruction to the service provider device to instruct the service provider device to provide the low latency service flow to the service receiving device for a predetermined period of time and based on the comparison or to the provisioning system to instruct the provisioning system to cause the service provider device to provide the low latency service flow to the service receiving device for a predetermined period of time and based on the comparison; and
automatically transmitting, via the processor, a message instruction to instruct the user of the low latency service flow and based on the predetermined period of time.

9. The method of claim 8, for use with a cable modem termination system (CMTS) as the service provider device, a cable modem as the service receiving device, the CMTS being configured to provide the service flow as a data over cable service interface specifications (DOCSIS) service flow to the cable modem and being configured to provide the low latency service flow as a low latency DOCSIS (LLD) service flow to the cable modem,
wherein said obtaining the comparison comprises obtaining the comparison as a second comparison of at least one of the upstream application data and the downstream application data to a low latency data threshold;
wherein said automatically transmitting the reconfigure instruction comprises automatically transmitting the reconfigure instruction to the CMTS to instruct the CMTS to provide the LLD service flow to the cable modem for a predetermined period of time and based on the second comparison or automatically transmitting the reconfigure instructions to the provisioning system to instruct the provisioning system to cause the CMTS to provide the LLD service flow to the cable modem for a predetermined period of time and based on the second comparison, and
wherein said automatically transmitting the message instruction comprises automatically transmitting the message instruction to instruct the user of the LLD service flow and based on the predetermined period of time.

10. The method of using a server device of claim 9, further comprising:
storing, via the processor and into a memory, an association between the cable modem and the user; and
storing, via the processor and into the memory, contact information of the user.

11. The method of using a server device of claim 10, wherein said storing the contact information of the user comprises storing, via the processor, the contact information of the user as one of a telephone number and an email address.

12. The method of using a server device of claim 11 additionally with a wireless network, the client device being configured to communicate with the wireless network based on the telephone number,
wherein said storing the contact information comprises storing, via the processor, the contact information of the user as the telephone number, and
wherein said automatically transmitting the message instruction comprises automatically transmitting, via the processor, the message instruction to the client device by way of the wireless network.

13. The method of using a server device of claim 11, the client device being configured to receive the message instruction based on the email address,
wherein said storing the contact information comprises storing, via the processor, the contact information of the user as an email address, and
wherein said automatically transmitting the message instruction comprises automatically transmitting, via the processor, the message instruction to the client device using the email address.

14. The method of using a server device of claim 9, further comprising automatically transmitting, via the processor, a second reconfigure instruction to the CMTS to instruct the CMTS to cease providing the LLD service flow to the cable modem after expiration of the predetermined period of time.

15. A non-transitory, computer-readable media having computer-readable instructions stored thereon, the computer-readable instructions being capable of being read by a server device for use with a service provider device, a service receiving device, a provisioning system, a client device, and a user, the service provider device being configured to provide a service flow to the service receiving device and being configured to provide a low latency service flow to the service receiving device, the low latency service flow having a latency that is lower than that of the service flow, the provisioning system being configured to provision the service receiving device to receive the service flow or the low latency service flow, the client device being configured to operate an application for use by the user and to provide upstream application data based on the application to the service provider device via the service receiving device and to receive downstream application data based on the application from the service provider device via the service receiving device, wherein the computer-readable instructions are capable of instructing the server device to perform the method comprising:
obtaining, via a processor, monitored data based on at least one of the upstream application data and the downstream application data;
obtaining, via the processor, a comparison of the monitored data to a low latency data threshold;
automatically transmitting, via the processor, a reconfigure instruction to the service provider device to instruct the service provider device to provide the low latency service flow to the service receiving device for a predetermined period of time and based on the comparison or to the provisioning system to instruct the provisioning system to cause the service provider device to provide the low latency service flow to the service receiving device for a predetermined period of time and based on the comparison; and
automatically transmitting, via the processor, a message instruction to instruct the user of the low latency service flow and based on the predetermined period of time.

16. The non-transitory, computer-readable media of claim 15, for use with a cable modem termination system (CMTS) as the service provider device, a cable modem as the service receiving device, the CMTS being configured to provide the service flow as a data over cable service interface specifications (DOCSIS) service flow to the cable modem and being configured to provide the low latency service flow as a low latency DOCSIS (LLD) service flow to the cable modem, wherein the computer-readable instructions are capable of instructing the server device to perform the method,
wherein said obtaining the comparison comprises obtaining the comparison as a second comparison of the at least one of the upstream application data and the downstream application data to a low latency data threshold;
wherein said automatically transmitting the reconfigure instruction comprises automatically transmitting the reconfigure instruction to the CMTS to instruct the CMTS to provide the LLD service flow to the cable modem for a predetermined period of time and based on the second comparison or automatically transmitting the reconfigure instructions to the provisioning system to instruct the provisioning system to cause the CMTS to provide the LLD service flow to the cable modem for a predetermined period of time and based on the second comparison, and
wherein said automatically transmitting the message instruction comprises automatically transmitting the message instruction to instruct the user of the LLD service flow and based on the predetermined period of time.

17. The non-transitory, computer-readable media of claim 16, wherein the computer-readable instructions are capable of instructing the server device to perform the method further comprising:
storing, via the processor and into a memory, an association between the cable modem and the user; and
storing, via the processor and into the memory, contact information of the user.

18. The non-transitory, computer-readable media of claim 17, wherein the computer-readable instructions are capable of instructing the server device to perform the method wherein said storing the contact information of the user comprises storing, via the processor, the contact information of the user as one of a telephone number and an email address.

19. The non-transitory, computer-readable media of claim 18, wherein at least one of:
the server device being additionally for use with a wireless network, the client device being configured to communicate with the wireless network based on the telephone number, wherein the computer-readable instructions are capable of instructing the server device to perform the method wherein said storing the contact information comprises storing, via the processor, the contact information of the user as the telephone number, and wherein said automatically transmitting the message instruction comprises automatically transmitting, via the processor, the message instruction to the client device by way of the wireless network; and
the client device being configured to receive the message instruction based on the email address, wherein the computer-readable instructions are capable of instructing the server device to perform the method wherein said storing the contact information comprises storing, via the processor, the contact information of the user as an email address, and wherein said automatically transmitting the message instruction comprises automatically transmitting, via the processor, the message instruction to the client device using the email address.

20. The non-transitory, computer-readable media of claim 16, wherein the computer-readable instructions are capable of instructing the server device to perform the method further comprising automatically transmitting, via the processor, a second reconfigure instruction to the CMTS to instruct the CMTS to cease providing the LLD service flow to the cable modem after expiration of the predetermined period of time.
